(19) United States
(12) Patent Application Publication
(10) Pub. No.: US 2015/0193687 A1
(43) Pub. Date: Jul. 9, 2015

(54) APPARATUS AND METHOD FOR EVALUATING GOALS OF CYBER-PHYSICAL SYSTEM

(71) Applicant: Electronics and Telecommunications Research Institute, Daejeon (KR)

(72) Inventors: Jeong-Min PARK, Daejeon (KR); In-Geol CHUN, Daejeon (KR); Sung-Joo KANG, Daejeon (KR); Jae-Ho JEON, Daejeon (KR); Won-Tae KIM, Asan (KR)

(21) Appl. No.: 14/590,874

(22) Filed: Jan. 6, 2015

(30) Foreign Application Priority Data
Jan. 7, 2014 (KR) 10-2014-0001743

(51) Int. Cl. G06N 5/04

(52) U.S. Cl. CPC G06N 5/04

(57) ABSTRACT

Disclosed herein are an apparatus and method that set the goals of a cyber-physical system, evaluate the goals, and also evaluate the achievement ratios of the goals. The presented apparatus includes a goal knowledge conversion unit for creating a goal knowledge table based on an input goal model, a goal monitoring and analysis unit for analyzing success or failure of goals present in the goal knowledge table created by the goal knowledge conversion unit, and a goal evaluation unit for generating achievement ratios of the goals based on results of the goal monitoring and analysis unit.

### CROSS REFERENCE TO RELATED APPLICATION

This application claims the benefit of Korean Patent Application No. 10-2014-0001743, filed Jan. 7, 2014, which is hereby incorporated by reference in its entirety into this application.

### BACKGROUND OF THE INVENTION

1. Technical Field

The present invention relates generally to an apparatus and method for evaluating the goals of a cyber-physical system and, more particularly, to an apparatus and method for evaluating management goals in a cyber-physical system in which a plurality of embedded systems having an autonomous control function are operated.

2. Description of the Related Art

A Cyber-Physical System (CPS) refers to a system in which a physical system having a sensor/actuator, and networks and software for control are integrated.

Such a cyber-physical system chiefly has two components. First is a physical environment (physical world) that can be directly viewed and touched in the real world, and second is a virtual environment (cyber world) that is present with the help of software. The physical world denotes an environment in which tangible physical entities, such as water, fire, buildings, weather, national defense, and traffic entities, are operated, and the cyber world denotes an environment that includes objects configured using software and are not visually perceived with eyes, but are felt to be present.

Therefore, Cyber-Physical Systems (CPSs) have grown gradually more complicated due to interactions with various embedded systems present in the CPSs.

In order to reduce such complexity, autonomous control technology for securing high-reliability of a CPS has appeared, and goal models generated in a design procedure for autonomous control must be utilized as core knowledge of autonomous control technology.

Due to an increase in the complexity of management of a CPS and the maintenance of the system, autonomous control technology denotes technology for allowing the system to be managed autonomously by deviating from human management, and for reducing system maintenance costs.

A lot of time and effort are required to recognize problems occurring in a cyber-physical system and to solve the recognized problems. As a methodology for solving such problems, autonomous control technology is a field of very important research that is currently attracting attention.

Autonomous control research for a highly-reliable cyber-physical system includes the following issues:

\textcircled{1} Goal modeling: as core knowledge of an autonomous control mechanism for guaranteeing a highly-reliable cyber-physical system, goals to be achieved during operation must be described.

\textcircled{2} Monitoring: whether a system in execution violates goals must be monitored.

\textcircled{3} Analysis: the results of monitoring are analyzed to detect the seriousness of problems, and whether to perform autonomous control must be determined depending on the degree of seriousness.

\textcircled{4} Diagnosis: the causes of problems are diagnosed and solutions based on diagnosis must be proposed.

\textcircled{5} Execution: the structure or behavior of the system in execution must be able to be dynamically arranged or executed by selecting a proposed solution.

\textcircled{6} Evaluation: the achievement ratio of a goal that is core knowledge of the system must be evaluated.

The present invention is intended to limitedly describe only the evaluation of a goal model, which is the core knowledge of autonomous control technology, among the above-described issues.

In a typical computing environment, a task for allowing a human being to maintain and manage a system is a very important but difficult task. In particular, the recognition of problems occurring in the system and the solution of the recognized problems without designating a specific goal of the system require a lot of time and effort. Existing research related to autonomous control technology may be classified into component-based, model-based, and log-based methodologies.

However, such research has the common problem that a definite “goal model” is not present, and thus it is difficult for the developer of “autonomous control” to personally analyze the complicated internal structure of the system and it is almost impossible to measure the achievement ratios of goals due to the huge criteria and scale of system management.

As related preceding technology, Korean Patent Application Publication No. 2010-0010758 (entitled “Method and device for generating of code”) discloses technology in which an a self-adaptive module activates/deactivates components for respective steps using the concept of a switch, thus reducing the amount of resources used by the system.

The invention disclosed in Korean Patent Application Publication No. 2010-0010758 is merely intended to generate a code based on a goal graph so as to diagnose the causes of a specific condition when the specific condition occurs in the system, and does not present evaluation or importance for the achievement ratio of the goal.

### SUMMARY OF THE INVENTION

Accordingly, the present invention has been made keeping in mind the above problems occurring in the prior art, and an object of the present invention is to provide an apparatus and method that set the goals of a cyber-physical system, evaluate the goals, and also evaluate the achievement ratios of the goals.

In accordance with an aspect of the present invention to accomplish the above object, there is provided an apparatus for evaluating goals of a cyber-physical system, including a goal knowledge conversion unit for creating a goal knowledge table based on an input goal model; a goal monitoring and analysis unit for analyzing success or failure of goals present in the goal knowledge table created by the goal knowledge conversion unit; and a goal evaluation unit for generating achievement ratios of the goals based on results of the goal monitoring and analysis unit.

The results of the goal monitoring and analysis unit may include a goal success list and a goal failure list.

The goal evaluation unit may use a function for measuring a total goal achievement ratio, a function for measuring an achievement ratio of each sub goal, and a function for normalizing weights of sibling goals of a specific sub goal when an achievement ratio of the specific sub goal is 0, in order to generate the achievement ratios of the goals.

The goal knowledge table may include a field for identifier information of an uppermost goal, a field for identifier information of a child goal of each goal, a field for name information of each goal, a field for information about constraints that must not be violated, a field for weight information assigned to each goal, a field for information required to identify a mandatory goal essential to be achieved, and a field for information required to identify whether a given goal is a last leaf-node.

The field for information required to identify whether the given goal is the last leaf-node may be indicated by “true” if the given goal is the last leaf-node, and constraint information may be connected to the last leaf-node.

The goal model may include information about goal identifiers, names of goals to be achieved by a system, weights to be achieved for respective goals, a mandatory goal essential to be achieved, and constraints that must not be violated by goals.

The apparatus may further include a result recording unit for recording the achievement ratios of the goals generated by the goal evaluation unit.

In accordance with another aspect of the present invention to accomplish the above object, there is provided a method for evaluating goals of a cyber-physical system, including creating, by a goal knowledge conversion unit, a goal knowledge table based on an input goal model; analyzing, by a goal monitoring and analysis unit, success or failure of goals present in the created goal knowledge table; and generating, by a goal evaluation unit, achievement ratios of the goals based on results of analysis of success or failure of the goals.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the configuration of an apparatus for evaluating the goals of a cyber-physical system according to an embodiment of the present invention;

FIG. 2 is a flowchart showing a method for evaluating the goals of a cyber-physical system according to an embodiment of the present invention;

FIGS. 3 to 12 are diagrams employed in the description of the method for evaluating the goals of a cyber-physical system according to the embodiment of the present invention; and

FIG. 13 is an embodiment of the present invention implemented in a computer system.

### DESCRIPTION OF THE PREFERRED EMBODIMENTS

The present invention may be variously changed and may have various embodiments, and specific embodiments will be described in detail below with reference to the attached drawings.

However, it should be understood that those embodiments are not intended to limit the present invention to specific disclosure forms and they include all changes, equivalents or modifications included in the spirit and scope of the present invention.

The terms used in the present specification are merely used to describe specific embodiments and are not intended to limit the present invention. A singular expression includes a plural expression unless a description to the contrary is specifically pointed out in context. In the present specification, it should be understood that the terms such as “include” or “have” are merely intended to indicate that features, numbers, steps, operations, components, parts, or combinations thereof are present, and are not intended to exclude a possibility that one or more other features, numbers, steps, operations, components, parts, or combinations thereof will be present or added.

Unless differently defined, all terms used here including technical or scientific terms have the same meanings as the terms generally understood by those skilled in the art to which the present invention pertains. The terms identical to those defined in generally used dictionaries should be interpreted as having meanings identical to contextual meanings of the related art, and are not interpreted as being ideal or excessively formal meanings unless they are definitely defined in the present specification.

Embodiments of the present invention will be described in detail with reference to the accompanying drawings. In the following description of the present invention, the same reference numerals are used to designate the same or similar elements throughout the drawings and repeated descriptions of the same components will be omitted.

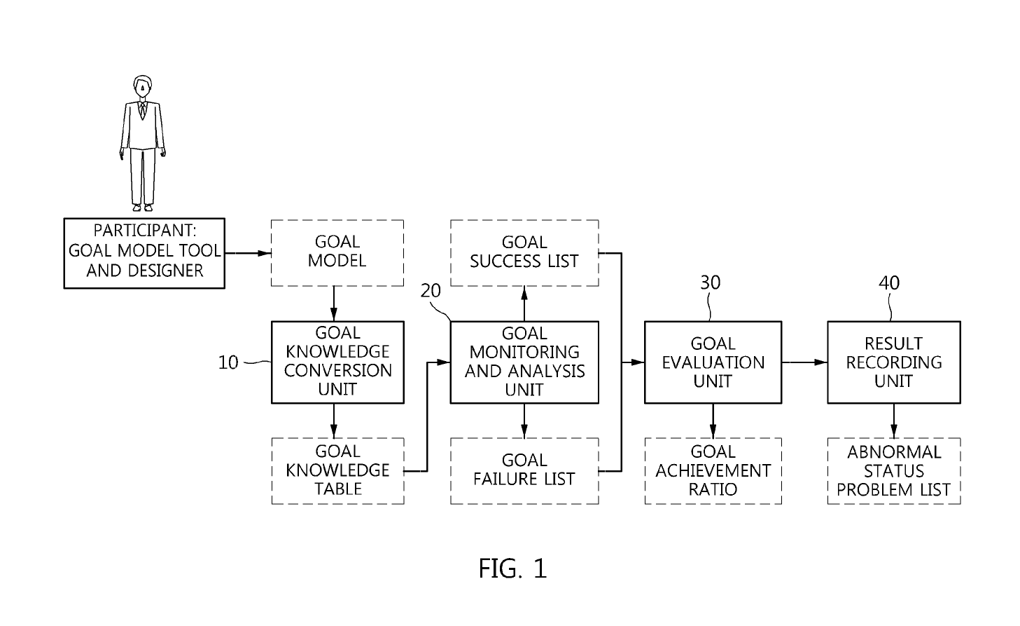

FIG. 1 is a configuration diagram showing an apparatus for evaluating the goals of a cyber-physical system according to an embodiment of the present invention.

The apparatus for evaluating the goals of a cyber-physical system according to an embodiment of the present invention includes a goal knowledge conversion unit 10, a goal monitoring and analysis unit 20, a goal evaluation unit 30, and a result recording unit 40.

The goal knowledge conversion unit 10 analyzes a goal model created by a system designer using a goal modeling tool (not shown) and creates the analyzed results as knowledge. That is, the goal knowledge conversion unit 10 constructs goal knowledge by arranging a goal model into a database (DB). In other words, the goal knowledge conversion unit 10 may receive the goal model and create a goal knowledge table. The goal knowledge conversion unit 10 may analyze meta-information via the goal model and extract pieces of information, such as Root Goal ID, Sub Goal ID, Goal Name, Constraint Name, Weight, Mandatory, and IsLeaf.

The goal monitoring and analysis unit 20 analyzes the success or failure of the goals present in the goal knowledge table created by the goal knowledge conversion unit 10. That is, the goal monitoring and analysis unit 20 separates given goals into a goal success list and a goal failure list by monitoring the given goals.

In other words, the goal monitoring and analysis unit 20 receives the goal knowledge table from the goal knowledge conversion unit 10 and separates the goal knowledge table into a goal success list and a goal failure list. Here, the goal success list is used to identify goals that have been achieved among the goals, and the goal failure list is used to identify goals that have not been achieved due to the abnormal operation among goals.

The goal evaluation unit 30 generates the achievement ratios of goals from the results of the goal monitoring and analysis unit 20. That is, the goal evaluation unit 30 receives the goal success list and the goal failure list from the goal monitoring and analysis unit 20, and measures the achievement ratios of the goals based on the lists.

In particular, the goal evaluation unit 30 may measure the total goal achievement ratio and the achievement ratio of each sub goal. Further, the goal evaluation unit 30 may normalize weights of sibling goals of a specific sub goal when the achievement ratio of the specific sub goal is 0 (zero).

The result recording unit 40 records the achievement ratios of goals measured by the goal evaluation unit 30.

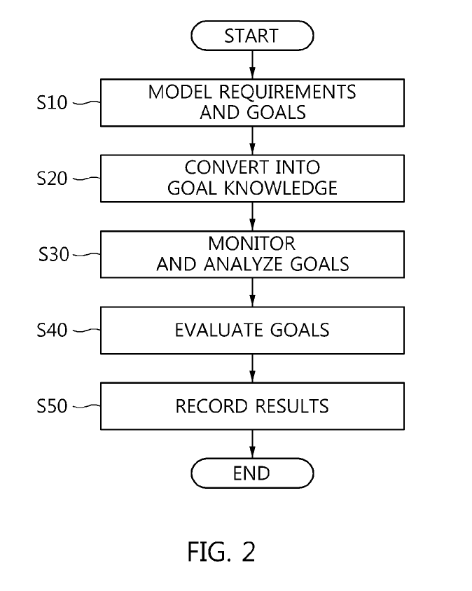

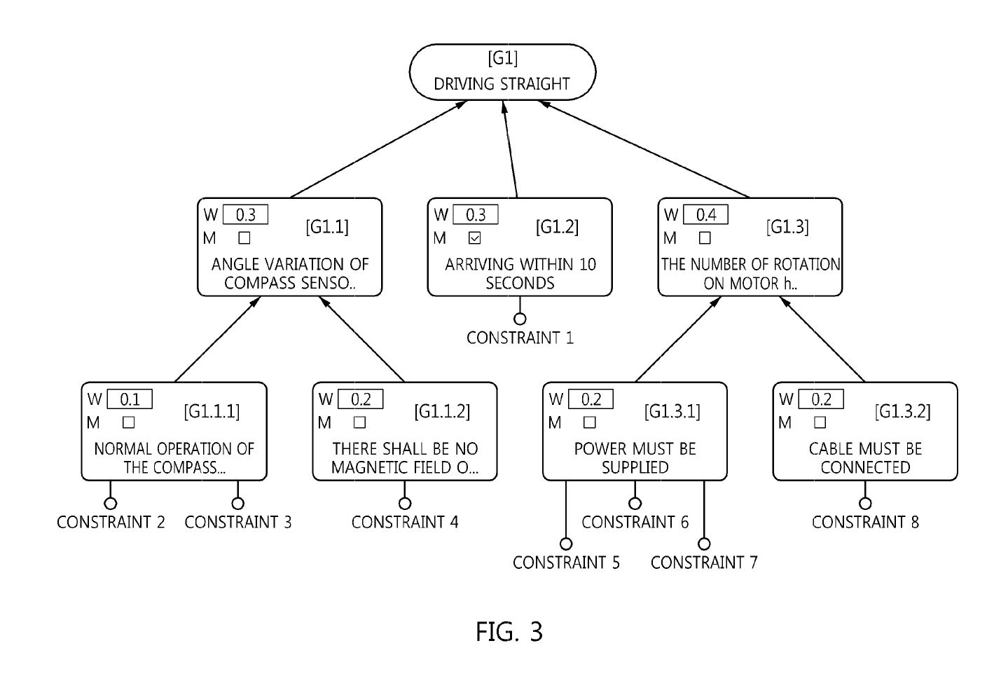

FIG. 2 is a flowchart showing a method for evaluating the goals of a cyber-physical system according to an embodiment of the present invention, and FIGS. 3 to 12 are diagrams employed in the description of the method for evaluating the goals of the cyber-physical system according to the embodiment of the present invention.

At step S10, a participant or a system designer models the goals of a management system using a goal modeling tool (not shown) or the like. FIG. 3 illustrates a goal model created by the system designer using the goal modeling tool. Here, the goal model may include the following five pieces of information:

1) Goal ID: goal identifiers (IDs) such as G1, G1.1, and G1.2

2) Goal name: names of goals to be achieved by the system

3) Weight (W): weights to be achieved for respective goals

4) Mandatory (M): mandatory goal essential to be achieved

5) Constraints: constraints that must not be violated by goals

In FIG. 3, goal IDs, goal names, weights, mandatory goal, and constraints are illustrated. G1 denotes a root goal and must satisfy ‘1’ (100% of goal achievement ratio) that is the sum of weights of G1.1, G1.2, and G1.3. G1.1 denotes a sub goal and must satisfy ‘0.3’ (30% of goal achievement ratio) that is the sum of weights of G1.1.1 and G1.1.2. G1.2 denotes a leaf-node and is connected to constraint. G1.3 denotes a sub goal and must satisfy ‘0.4’ (40% of goal achievement ratio) that is the sum of weights of G1.3.1 and G1.3.2. G1.1.1, G1.1.2, G1.3.1, and G1.3.2 denote leaf-nodes and are each connected to constraints.

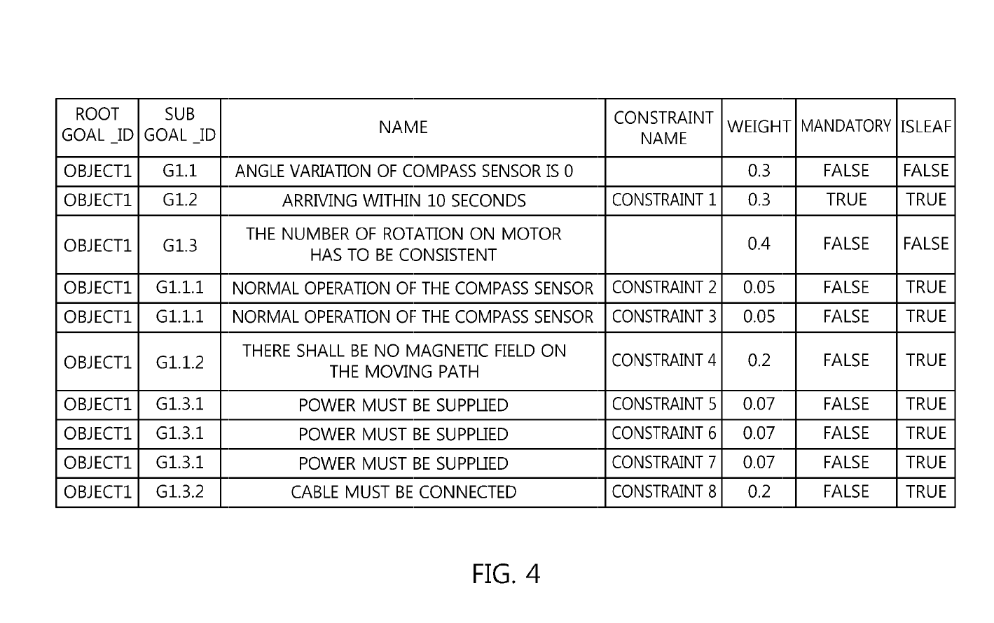

Then, at step S20, the goal knowledge conversion unit 10 analyzes the goal model and creates the results of analysis as knowledge. That is, the goal knowledge conversion unit 10 receives the goal model and creates a goal knowledge table. The goal knowledge conversion unit 10 may analyze meta-information using the goal model of FIG. 3 and extract pieces of information such as Root Goal ID, Sub Goal ID, Goal Name, Constraint Name, Weight, Mandatory, and IsLeaf information. The illustration of storage fields shown in FIG. 4 is an example of the goal knowledge table exported by the goal knowledge conversion unit 10. By means of a product such as that shown in FIG. 4, knowledge enabling the achievement ratios of goals to be measured may be created.

Here, the goal knowledge table includes the following pieces of information:

1) Root Goal_ID: identifier (ID) information of an uppermost (root) goal

2) Sub Goal_ID: ID of the child goal (sub goal) of each goal

3) Name: name information of goal

4) Constraint Name: information about constraints that must not be violated

5) Weight: weight information assigned to each goal

6) Mandatory: information required to identify a mandatory goal that is essential to be achieved

7) IsLeaf: information required to identify whether a given goal is a last leaf-node, wherein if it is determined that the goal is the last leaf-node, the goal is indicated by “true” and is connected to constraint information

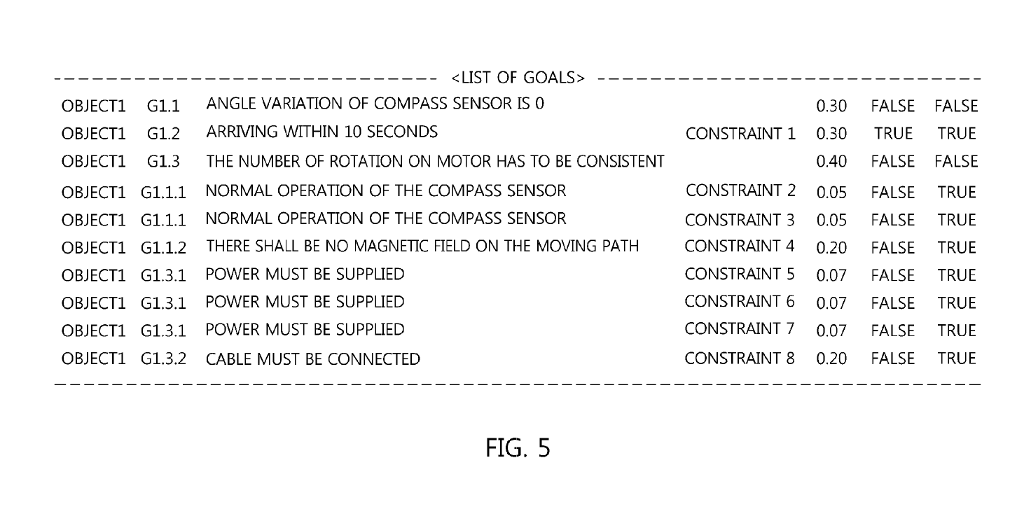

Thereafter, at step S30, the goal monitoring and analysis unit 20 analyzes the success or failure of goals based on the goal knowledge table. That is, the goal monitoring and analysis unit 20 separates given goals into a goal success list and a goal failure list by monitoring the given goals. In other words, the goal monitoring and analysis unit 20 receives the goal knowledge table such as that shown in FIG. 4 from the goal knowledge conversion unit 10, and separates the goal knowledge table into the goal success list and the goal failure list. FIG. 5 illustrates a list of goals read by the goal monitoring and analysis unit 20 as input values. Here, the goal monitoring and analysis unit 20 monitors constraints corresponding to Constraint 1 to Constraint 8 and separates achieved goals and violated goals.

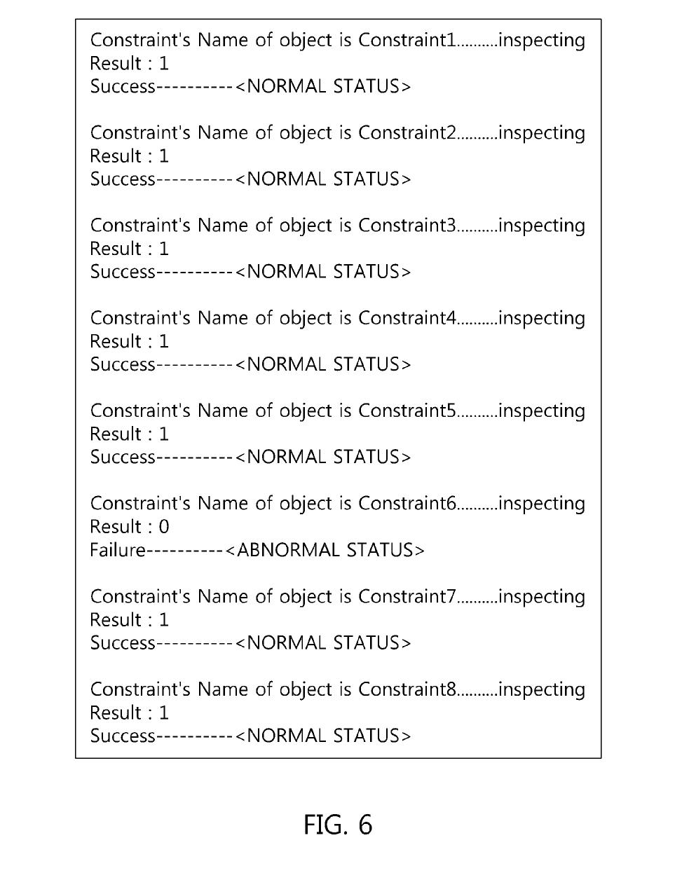

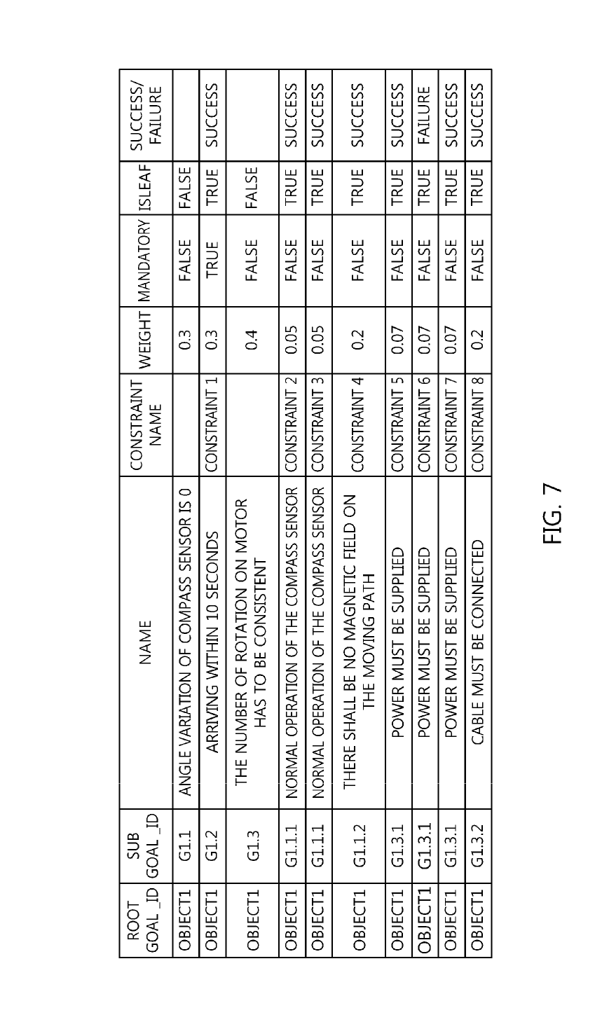

The final results analyzed by the goal monitoring and analysis unit 20 may be illustrated, as shown in FIGS. 6 and 7. In the results of monitoring and analysis of goals, Result: 1 means a success, and Result: 0 means a failure. FIGS. 6 and 7 show that, among 8 goals to be monitored, one goal (that is, Constraint 6) could not be successfully achieved.

By means of such monitoring and analysis activities, the success and failure of all goals may be measured, and adaptation strategies of goals that are abnormally executed may be planned.

Then, at step S40, the goal evaluation unit 30 generates the achievement ratios of goals via the products generated by the goal monitoring and analysis unit 20. That is, the goal evaluation unit 30 receives the goal success list and the goal failure list of FIGS. 6 and 7, and measures the achievement ratios of the goals.

The goal evaluation unit 30 has the following three functions so as to measure the achievement ratios of goals.

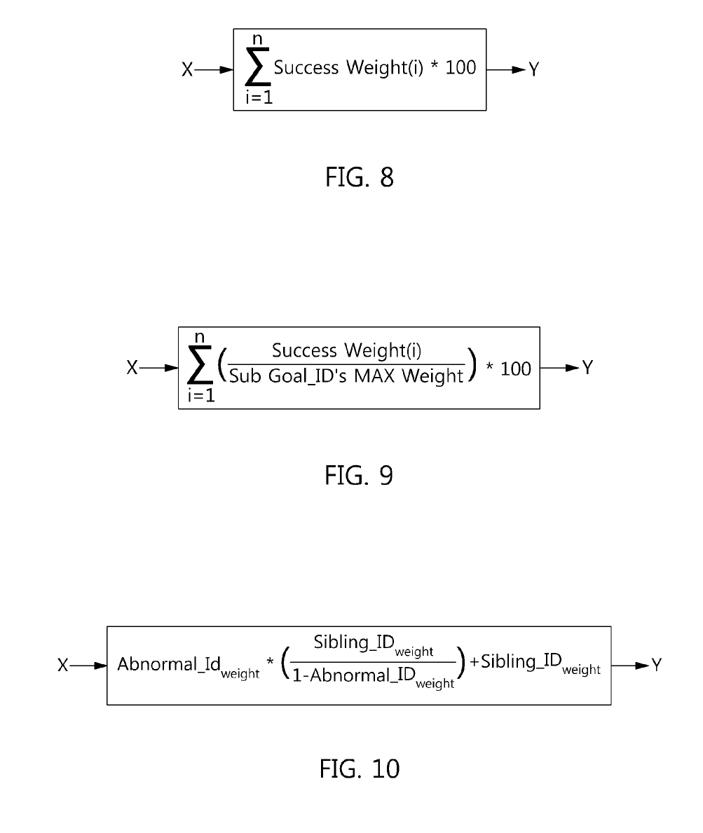

(1) Function 1: the calculating formula of FIG. 8 is used to measure a total goal achievement ratio.

In FIG. 8, input X denotes a Root Goal_ID, and output Y denotes a total goal achievement ratio. The condition of function 1 assumes a case where the “IsLeaf” column is “true” and the goal is “Success”, wherein function 1 is operated only when the condition of the case is fulfilled.

For example, by means of the function of FIG. 8, if the total goal achievement ratio Y of FIG. 7 is measured, values may be applied to the function of FIG. 8 as follows:

Y=(0.3+0.05+0.05+0.2+0.07+0.07+0.2)*100

∴Y=94%(total goal achievement ratio)

(2) Function 2: the calculating formula of FIG. 9 is used to measure the achievement ratio of each sub goal.

In FIG. 9, input X denotes a Sub Goal_ID, and output Y denotes the achievement ratio of each sub goal. The condition of function 2 assumes a case where the child of input Sub Goal_ID is present and the “IsLeaf” column is “true” and where the goal is “Success”, wherein function 2 is operated only when the condition of the case is fulfilled.

For example, when the sub goal achievement ratio Y of “G1.3” that is the Sub Goal_ID of FIG. 7 is measured using the function of FIG. 9, values may be applied to the function of FIG. 9 as follows.

MAX Weight of G1.3=0.4

Child goals of G1.3={G1.3.1, G1.3.1, G1.3.1, G1.3.2}

Success Weights of child goals of G1.3={0.07, failure, 0.07, 0.2}

Y=((0.07+0+0.07+0.2)/0.4)*100

∴Y=85%(achievement ratio of sub goal G1.3)

(3) Function 3: when the achievement ratio of a specific sub goal is 0, the calculating formula of FIG. 10 is used to normalize the weights of sibling goals of the specific sub goal.

In FIG. 10, input X denotes an abnormal ID, and output Y denotes a changed weight. The condition of function 3 assumes a case where the achievement ratio of a sub goal is 0 and the sub goal has sibling goals, wherein function 3 is operated only when the condition of the case is fulfilled.

For example, when an achievement ratio calculated by measuring the sub goal achievement ratio of “G1.1” that is the Sub Goal_ID of FIG. 3 using the function of FIG. 10 is 0, G1.2 and G1.3, which are sibling goals of G1.1, are targets, the weights of which are to be normalized. Therefore, the weights may be applied as follows.

Abnormal_id_{weight}=0.3 (weight of G1.1)

Sibling_IDs of G1.1=G1.2, G1.3 (targets, weights of which are to be normalized)

Normalized weight of G1.2=0.3*(0.3/(1-0.3))+0.3=0.428

Normalized weight of G1.3=0.3*(0.4/(1-0.3))+0.4=0.571

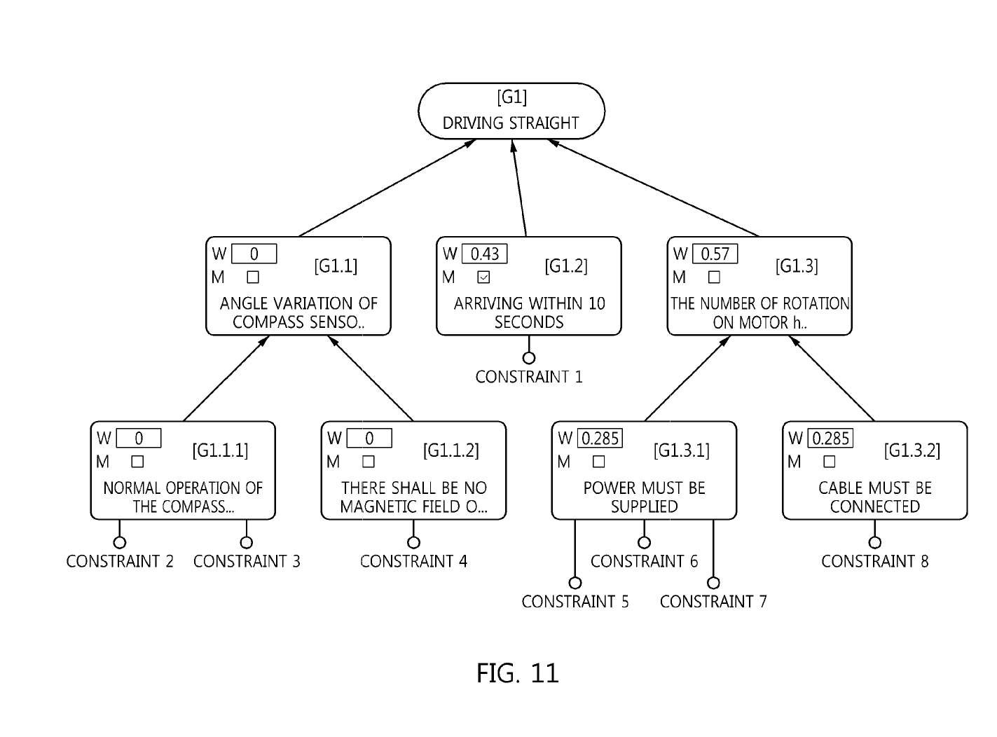

FIG. 11 shows that the weights of G1.1, G1.2, and G1.3 are normalized. When comparing FIG. 11 with FIG. 3, differences appearing before and after weights are normalized can be seen.

In other words, by means of a procedure of normalizing weights, goals that cannot be achieved may be easily identified, and thus the priorities of goals may be changed.

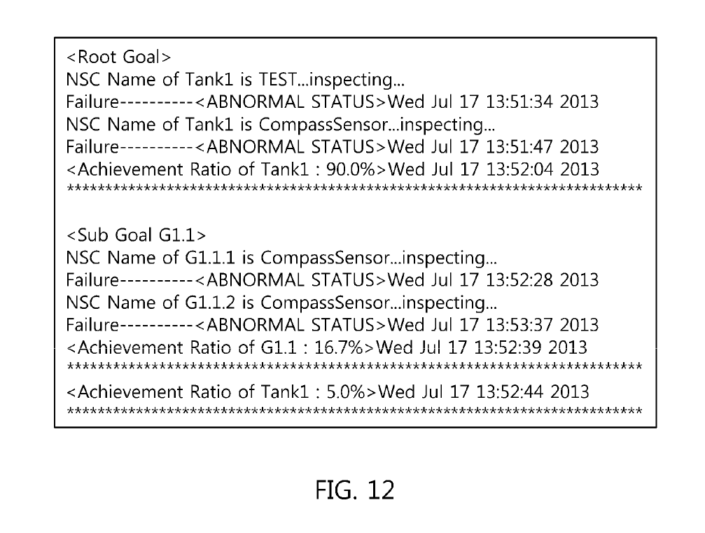

Finally, at step S50, the result recording unit 40 records the achievement ratios of goals. FIG. 12 shows that <ABNORMAL STATUS> is recorded by the result recording unit 40, and that the goal achievement ratio of <Root Goal> and goal achievement ratios of <Sub Goals> are recorded.

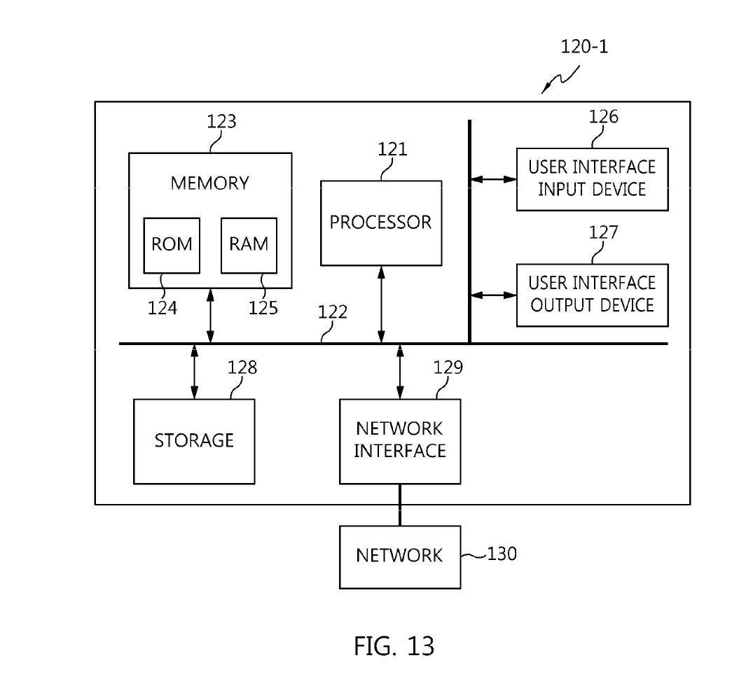

FIG. 13 is an embodiment of the present invention implemented in a computer system.

Referring to FIG. 13, an embodiment of the present invention may be implemented in a computer system, e.g., as a computer readable medium. As shown in in FIG. 13, a computer system 120-1 may include one or more of a processor 121, a memory 123, a user interface input device 126, a user interface output device 127, and a storage 128, each of which communicates through a bus 122. The computer system 120-1 may also include a network interface 129 that is coupled to a network 130. The processor 121 may be a central processing unit (CPU) or a semiconductor device that executes processing instructions stored in the memory 123 and/or the storage 128. The memory 123 and the storage 128 may include various forms of volatile or non-volatile storage media. For example, the memory may include a read-only memory (ROM) 124 and a random access memory(RAM) 125.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

In accordance with the present invention having the above configuration, a goal model may be set to core knowledge for the management of a system, and the achievement ratios of set goals may be measured.

That is, the goals of the cyber-physical system are set and are evaluated, and the achievement ratios of the goals are calculated, and thus the goal of the entire system may be analyzed.

Further, the present invention is highly advantageous in that goals that cannot be achieved are identified via a weight normalization procedure, and the priorities of goals are changed.

As described above, optimal embodiments of the present invention have been disclosed in the drawings and the specification. Although specific terms have been used in the present specification, these are merely intended to describe the present invention and are not intended to limit the meanings thereof or the scope of the present invention described in the accompanying claims. Therefore, those skilled in the art will appreciate that various modifications and other equivalent embodiments are possible from the embodiments. Therefore, the technical scope of the present invention should be defined by the technical spirit of the claims.

What is claimed is:

1. An apparatus for evaluating goals of a cyber-physical system, comprising:
a goal knowledge conversion unit for creating a goal knowledge table based on an input goal model;
a goal monitoring and analysis unit for analyzing success or failure of goals present in the goal knowledge table created by the goal knowledge conversion unit; and
a goal evaluation unit for generating achievement ratios of the goals based on results of the goal monitoring and analysis unit.

2. The apparatus of claim 1, wherein the results of the goal monitoring and analysis unit include a goal success list and a goal failure list.

3. The apparatus of claim 1, wherein the goal evaluation unit uses a function for measuring a total goal achievement ratio, a function for measuring an achievement ratio of each sub goal, and a function for normalizing weights of sibling goals of a specific sub goal when an achievement ratio of the specific sub goal is 0, in order to generate the achievement ratios of the goals.

4. The apparatus of claim 1, wherein the goal knowledge table includes a field for identifier information of an uppermost goal, a field for identifier information of a child goal of each goal, a field for name information of each goal, a field for information about constraints that must not be violated, a field for weight information assigned to each goal, a field for information required to identify a mandatory goal essential to be achieved, and a field for information required to identify whether a given goal is a last leaf-node.

5. The apparatus of claim 4, wherein the field for information required to identify whether the given goal is the last leaf-node is indicated by “true” if the given goal is the last leaf-node, and constraint information is connected to the last leaf-node.

6. The apparatus of claim 1, wherein the goal model includes information about goal identifiers, names of goals to be achieved by a system, weights to be achieved for respective goals, a mandatory goal essential to be achieved, and constraints that must not be violated by goals.

7. The apparatus of claim 1, further comprising a result recording unit for recording the achievement ratios of the goals generated by the goal evaluation unit.

8. A method for evaluating goals of a cyber-physical system, comprising:
creating, by a goal knowledge conversion unit, a goal knowledge table based on an input goal model;
analyzing, by a goal monitoring and analysis unit, success or failure of goals present in the created goal knowledge table; and
generating, by a goal evaluation unit, achievement ratios of the goals based on results of analysis of success or failure of the goals.

9. The method of claim 8, wherein the results of analysis of success or failure of the goals include a goal success list and a goal failure list.

10. The method of claim 8, wherein generating the achievement ratios of the goals comprises generating the achievement ratios of the goals using a function for measuring a total goal achievement ratio, a function for measuring an achievement ratio of each sub goal, and a function for normalizing weights of sibling goals of a specific sub goal when an achievement ratio of the specific sub goal is 0.

11. The method of claim 8, wherein the goal knowledge table includes a field for identifier information of an uppermost goal, a field for identifier information of a child goal of each goal, a field for name information of each goal, a field for information about constraints that must not be violated, a field for weight information assigned to each goal, a field for information required to identify a mandatory goal essential to be achieved, and a field for information required to identify whether a given goal is a last leaf-node.

12. The method of claim 11, wherein the field for information required to identify whether the given goal is the last leaf-node is indicated by “true” if the given goal is the last leaf-node, and constraint information is connected to the last leaf-node.

13. The method of claim 8, wherein the goal model includes information about goal identifiers, names of goals to be achieved by a system, weights to be achieved for respective goals, a mandatory goal essential to be achieved, and constraints that must not be violated by goals.

14. The method of claim 8, further comprising, after generating the achievement ratios of the goals:
recording, by a result recording unit, the generated achievement ratios of the goals.
